(19) United States
(12) Patent Application Publication
(10) Pub. No.: US 2022/0185157 A1
(43) Pub. Date: Jun. 16, 2022

(54) ARMREST DEVICE FOR A BACKREST OF A SEAT, BACKREST COMPRISING AN ARMREST DEVICE AND SEAT

(71) Applicant: Adient Engineering and IP GmbH, Burscheid (DE)

(72) Inventors: Michael J. KAPUSKY, South Lyon, MI (US); Nathan CARUSS, Ann Arbor, MI (US); Jennifer J. CARLSON, Ypsilanti, MI (US)

(73) Assignee: Adient Engineering and IP GmbH, Burscheid (DE)

(21) Appl. No.: 17/310,737

(22) PCT Filed: Feb. 5, 2020
(86) PCT No.: PCT/EP2020/052860

§ 371 Date: Aug. 20, 2021

Related U.S. Application Data
(60) Provisional application No. 62/808,867, filed on Feb. 22, 2019.

(51) Int. Cl. B60N 2/75

(52) U.S. Cl. CPC B60N 2/753

(57) ABSTRACT

An armrest device for a backrest of a vehicle seat may have at least an armrest body which is pivotable between a horizontal use position (UP) and a vertical stowed position (SR). The device may also have an armrest carrier structure. In the horizontal use position the armrest body may be located substantially laterally with respect to the armrest carrier structure and in the vertical stowed position the armrest body may be located substantially behind the armrest carrier structure. A backrest and a seat may use the armrest device.

### BACKGROUND OF THE DISCLOSURE

The present disclosure relates generally to an armrest device for a backrest, in particular of a vehicle seat. Further, the present disclosure relates generally to a backrest comprising an armrest device and a seat, in particular vehicle seat, comprising such a backrest.

An armrest device of a seat, such as a vehicle seat, is usually deployable to provide a support for a person's arm or stowable to maximize seating space.

For example, U.S. Pat. No. 7,255,402 B1 discloses a pivoting armrest assembly for a seat back.

### SUMMARY OF THE DISCLOSURE

It is an object of the present invention to provide armrest devices in order to increase comfort for an occupant, simplify an adjustment of an armrest for the occupant and to improve, in particular to decrease, a number of components. Furthermore, the object of the present invention is to provide a unique armrest device and adjustment motion as well as an increased optical appearance of the seat, for example of vehicles, autonomous driving vehicles, occupant transfer vehicles and airlines.

According to the armrest device, the object is solved by the features claimed in claim 1. According to the backrest comprising an armrest device, the object is solved by the features claimed in claim 13 and according to the seat, in particular a vehicle seat, the object is solved by the features claimed in claim 15.

According to the disclosure, an armrest device for a backrest of a seat, in particular a vehicle seat, comprises an armrest body which is pivotable between a horizontal use position and a vertical stowed position and an armrest carrier structure comprising a mounting plate having a first mounting surface mountable to the backrest and a second mounting surface. The armrest carrier structure further comprising a single pivot joint provided on the second mounting surface of the mounting plate, wherein the single pivot joint defines a pivot axis angled away from the mounting place. The armrest body is pivotable connected to the single pivot joint, wherein in the horizontal use position the armrest body is located substantially laterally with respect to the armrest carrier structure, in particular adjacent a lateral portion of the backrest. Moreover, in the vertical stowed position the armrest body is located substantially behind the armrest carrier structure.

So, in view of the backrest, the armrest body is arranged substantially behind the backrest in an area of the lateral portion in the vertical stowed position of the armrest body. Advantage of the disclosure is providing a simple, storable armrest that deploys from a hidden stowed position behind the seat on a single off-axis while meeting cost, mass and package constraints. The armrest carrier structure with the single pivot joint allows a smooth actuation of an armrest movement, in particular deployment and retraction. Moreover, the armrest device allows providing a thin armrest body with the introduced armrest carrier structure. In the hidden vertical stowed position, for example more free space, for instance egress and ingress may be provided to a passenger.

An advantage of the invention is that a simple, storable armrest is designed which deploys from a hidden stowed position behind a seat on a single off-axis while meeting cost, mass and package constraints. The hidden stowed position improves craftsmanship of the seat while the armrest is not being used. By applying knowledge of human anthropometry an optimal human interface can be created. The armrest can be easily stowed and deployed. An actuation is configured simple and smooth. Moreover, the armrest device comprises a thin armrest package and armrest support carrier package. Another advantage is that the armrest can be easily rotated out of the way for a seated occupant in emergency situations, so the occupant can easily exit the seat. Furthermore, the armrest can be easily stowed to provide entry space for the occupant. In particular, the armrest body is continuously movable about the single pivot axis. Moreover, the armrest device provides a substantially lightweight and simple design. The armrest device is applicable to common seats, in particular backrest shells or frames.

According to an embodiment, in a mounted state of the armrest carrier structure the mounting plate is arranged substantially vertically on the lateral portion of the backrest. The pivot axis is angled with respect to the vertical mounting plate. The single pivot joint has particularly a diagonal pivot axis with respect to a vertical axis defined through the vertical mounting plate such that in the vertical stowed position a longitudinal axis defined through the armrest body is positioned off-set relative to the longitudinal axis defined through the armrest body in the horizontal use position. For example, the longitudinal axis of the armrest body in the horizontal use position defines a vertical plane to which a vertical plane defined through the longitudinal axis of the armrest body in the vertical stowed position is located off-set. The armrest body is lockable in at least one of the positions by an integrated locking mechanism comprising at least one spring loaded device. In particular, a further pivoting about the pivot joint is prevented via the locking mechanism.

In particular, the angled pivot joint is configured to define an off-axis pivot about which the armrest body is pivotable. The armrest body is a carrier structure which is surrounded by foam and/or a covering element to provide a comfortable armrest to an occupant.

According to an embodiment, the armrest body comprises a free end and a coupling end which is connected to the single pivot joint. The coupling end comprises a linkage housing which is configured to accommodate the single pivot joint of the armrest carrier structure. For example, the armrest carrier structure comprises a pivot joint which is angled or rather tilted at a 45° axis relative to a vertical mounting plate which is attached to a seat structure, particularly a backrest frame. The movement of the armrest can be powered or manually carried out. In particular, the linkage housing is coupled to the armrest carrier structure by a pin, plunger or a bolt.

According another embodiment, the armrest carrier structure comprises a bracket mounted on the mounting plate, wherein the single pivot joint is projecting from the bracket. For instance, when the armrest support carrier is attached to the lateral portion of the backrest, the single pivot joint may project towards a lateral and a rear direction with respect to the lateral portion of the backrest.

According to a further embodiment, the mounting plate defines a plane, particularly a vertical plane, from which the pivot axis is angled away at an angle of about 20° to 50°, for example 25° to 45°, in particular 30° to 40°.

According another embodiment, the armrest body is moved about the pivot axis in a substantially arc-shaped or arched manner between the vertical stowed position and the horizontal use position. Thereby, the armrest body is movable in an arc-shaped or arched manner about the single pivot joint. In particular, a simple sweeping movement or motion may be carried out.

Such a positioning movement or motion of the armrest body is particularly visually appealing whilst providing a dynamic easy handling for the occupant. Moreover, the armrest body may be translated between the positions in one single movement. The pivot axis defined an arc-shaped or arched movement path followed by the armrest body, in particular by the coupling end, so that, starting from the vertical stowed position, the armrest body is rotated from a substantially aft vertical position behind the backrest about the lateral portion or lateral side of the backrest to the horizontal use position substantially perpendicular to the backrest, in particular parallel above a seat pan of the seat.

According to another embodiment, the armrest body is substantially L-shaped or J-shaped. This shape supports the arc-shaped single movement of the armrest body.

In another embodiment, wherein in the horizontal use position an upper usage surface of the armrest body substantially faces in a direction towards a ceiling of a vehicle, and in the vertical stowed position the upper usage surface substantially faces in a direction away from a front seating surface of the backrest, i.e. in an aft direction of the vehicle.

In a further embodiment, the armrest body and the armrest carrier structure comprises a number of integrated stops which engage each other when the armrest body reaches one of end positions such as the horizontal use position and the vertical stowed position. Thereby, no return spring, release handle or button or locking mechanism is required. The armrest body may be moved by a simple pull and push force by the occupant and user. Optionally or additionally, the armrest body may be latched in the vertical stowed positon, wherein the armrest body may be released via a simple push release mechanism.

According to an embodiment, the armrest body comprises at least one grip portion, such as an integrated and/or external handle, to be manually moved between the horizontal use position and the vertical stowed position. For example, the grip portion is a recess grip provided within the armrest body. Additionally or optionally, the armrest body comprises an external grip portion, such as a manual handle or a gripping bow.

In another embodiment, the armrest body comprises an arm support element, in particular an arm or support extension element, which is deployable and stowable depending on a movement of the armrest body from the vertical stowed position to the horizontal use position and vice versa. One end of the arm support element is connected to the coupling end of the armrest body and the other end is mountable to the backrest. The arm support element is, for example, made of fabric, textile or synthetic material. The arm support element is configured as a so called hammock extension which is in tension when the armrest body is in the horizontal use position and which folds behind the backrest when the armrest body is stowed. The arm support element is further configured to support an elbow region and upper arm region and/or shoulder region of the occupant seated on the seat. In the horizontal use position, the armrest body and the arm support element, in particular extension element, provide a continuous support surface for an occupant's arm.

According to the disclosure, an armrest device for a backrest of a seat, in particular a vehicle seat, comprises an armrest body which is pivotable between a horizontal use position and a vertical stowed position and an armrest carrier structure comprising a single pivot joint to which the armrest body is pivotable connected to, wherein the armrest body and the armrest carrier structure comprise a number of integrated stops which engage each other when the armrest body reaches one of the horizontal use position and the vertical stowed position. In particular, the integrated stops are configured as end stops such as raised portions.

According to the disclosure, an armrest device for a backrest of a seat, in particular a vehicle seat, comprises an armrest body which is pivotable between a horizontal use position and a vertical stowed position and an armrest carrier structure comprising a single pivot joint to which the armrest body is pivotable connected to, wherein the armrest body comprises at least one handle to manually move the armrest between the horizontal use position and the vertical stowed position. For example, the armrest body has an integrated handle on an inside or a bottom surface that allows an occupant to easily pull the armrest body from the vertical stowed position behind the seat to the horizontal use position next to the seat. No return spring, an additional release handle and/or button or further locking mechanism is required. The integrated handle is configured as a cavity on an inside of the armrest body. Optionally or additionally, the integrated handle is arranged on the bottom surface of the armrest body such as a handle extension to be pulled by the occupant.

According to the disclosure, an armrest device for a backrest of a seat, in particular a vehicle seat, comprises an armrest body which is pivotable between a horizontal use position and a vertical stowed position and an armrest carrier structure comprising a single pivot joint to which the armrest body is pivotable connected to, wherein the armrest body comprises an arm extension, particularly an elbow hammock extension. In particular, the arm extension is deployable and stowable depending on a movement of the armrest from the vertical stowed position to the horizontal use position and vice versa. The arm extension is arranged and/or coupled to a back of the armrest body to provide additional support to an elbow and arm, particularly an upper arm, of the occupant. The arm extension is attached to the back of the armrest body and a seat structure, in particular a backrest frame. For example, the arm extension is made of fabric in tension or comprises foam on top of the fabric for more comfort. Moreover, the arm extension support element is configured as a flexible element which is foldable to be stowed in the vertical stowed position of the armrest body and deployable to be used in the horizontal use position of the armrest body.

According to an embodiment, the armrest body is configured to continuously move along the diagonal pivot axis. The movement of the armrest body is a simple sweeping movement or motion. For example, the armrest body is movable in an arc-shaped manner about the single pivot joint or along an arcuate path defined by the diagonal pivot axis. Moreover, the armrest body is configured to be translated from the vertical stowed position to the horizontal use position and vice versa in one single movement. In particular, an off-axis stowable armrest body with respect to a vertical orientation defined by a backrest is provided by the invention.

The armrest device is mounted to a seat, for instance, at one side of the seat, in particular to a backrest frame. Particularly, in the vertical stowed position the armrest body is positioned vertically aligned at and/or behind a side portion of the seat. In the horizontal use position the armrest body is positioned substantially parallel with respect to a seat pan and distanced from the seat pan.

According to another possible embodiment, the spring loaded device comprises a ball nose configured to lock the armrest body in the vertical stowed position. Use of minimal number of parts is provided by this invention as well as no further mechanism and adjustment devices such as return springs for the locking mechanism and/or for bringing the armrest from the stowed position to the deployed position are needed. In particular, the spring loaded device is configured as a so called ball and spring plunger, wherein a plunger encloses a spring element, for instance in a capsule. The spring element is configured to apply accurate and repeatable forces through a ball and/or a rounded nose. An installation of such a locking mechanism having a spring loaded device can be carried out in an easy and cost reduced manner. The spring loaded device can be used for positioning, latching and locking. When the armrest body is pivoted from the vertical stowed position to the horizontal use position or vice versa, the ball nose is retracted into the plunger. For example, the spring loaded device is arranged in the linkage housing of the armrest body.

In a further embodiment, the armrest carrier structure comprises a locking divot into which the ball nose engages for locking the armrest body in the vertical stowed position. In particular, the ball nose of the spring loaded device is configured to go into the divot and hold the armrest body in the vertical stowed position. For instance, the divot is arranged on a surface of the angled pivot joint which faces the armrest body, particularly the linkage housing. A further divot could be added for the horizontal use position in order to prevent so called BSR (short for Buzz, Squeak and Rattle) concerns. This is one method for holding the armrest in each position whereas other methods could be used too. When the armrest body is pivoted from the vertical stowed position to the horizontal use position or vice versa, the ball nose is deployed when the spring loaded device reaches the locking divot by a spring force.

Further, the disclosure relates to a backrest for a seat, in particular vehicle seat, comprising at least one backrest frame, a backrest shell arranged on the backrest frame to support a person's, i.e. an occupant's back, and an armrest device as described above, wherein the armrest device is attached to a lateral portion of the backrest frame.

According to an embodiment, wherein in the horizontal use position the armrest body is located substantially perpendicular to a vertical orientation of the backrest shell and in the vertical stowed position the armrest body is located substantially behind the backrest shell and parallel relative to the vertical orientation of the backrest shell. For example, the backrest shell comprises lateral protruding portions which extend over an edge of the lateral portion of the backrest frame. For instance, the lateral protruding portion on side of the armrest device is configured to at least partially cover up the armrest body in the vertical stowed position.

According to an embodiment, the longitudinal axis position defined through the armrest body is positioned perpendicular to a vertical orientation of the backrest shell and substantially distanced relative to the backrest shell in the horizontal use position of the armrest body, wherein in the vertical stowed position of the armrest body the longitudinal axis position defined through the armrest body is positioned substantially parallel relative to the vertical orientation of the backrest shell and substantially behind the backrest shell.

Moreover, the disclosure relates to a seat, in particular a vehicle seat, such as an aircraft seat or an automotive seat or any seat for person transportation, comprising at least a seat pan, a backrest and an armrest device as described above.

For instance, the seat is rotatable relative to its vertical orientation. Adjusting the orientation of the seat can improve a seating comfort for an occupant of the seat. In addition the seat may be used for easier ingress to or egress from the vehicle, and allows an occupant to get to a comfortable position to relax. Moreover, the seat is configured to benefit mobility-challenged persons, for instance elderly and larger-sized individuals.

### BRIEF DESCRIPTION OF THE DRAWINGS

The present disclosure will become more fully understood from the detailed description given herein below and the accompanying drawings which are given by way of illustration only, and thus, are not limitative of the present disclosure, wherein:

FIGS. 1A to 1C show perspective views of a seat, in particular a vehicle seat,

FIGS. 2A and 2B show front views of the seat, wherein FIG. 2A shows armrests of the seat in a horizontal use position and FIG. 2B shows one of the armrests in a vertical stowed position,

FIG. 2C shows a perspective view of the seat having an armrest in a vertical stowed position according to FIG. 2B,

FIGS. 3A and 3B show perspective views of a section of the seat, wherein FIG. 3A shows the armrest in the horizontal use position and FIG. 3B shows the armrest in the vertical stowed position,

FIG. 4 shows an exploded view of an armrest device,

FIGS. 5A and 5B show the armrest device in a mounted state,

FIG. 6 shows a top view of the seat and an armrest deployment motion,

FIG. 7 shows a front view of a clearance between two armrests, wherein one armrest is mounted to a passenger seat and another armrest is mounted to a driver seat,

FIGS. 8A to 8C show perspective views of armrest embodiments with grip portions, and

FIGS. 9A to 9E show perspective views of armrest embodiments with arm extensions.

Corresponding parts are marked with the same reference symbols in all figures.

### DETAILED DESCRIPTION OF PREFERRED EMBODIMENTS

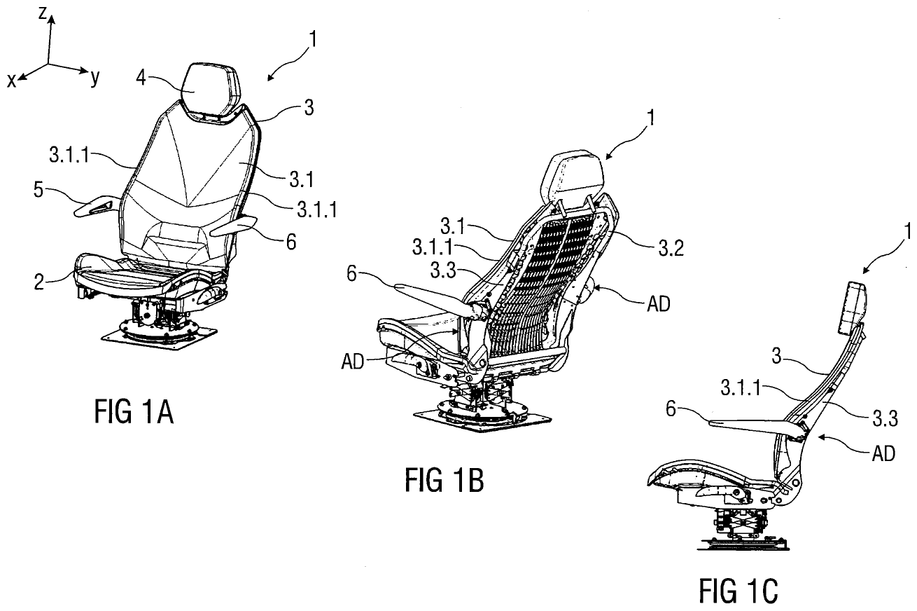

FIG. 1A to 1C show schematically perspective views of a seat 1, in particular a vehicle seat, for instance for autonomous driving vehicles or airplanes or any other passenger transport vehicle. In particular, FIG. 1A shows the seat 1 in a perspective front view, FIG. 1B shows the seat 1 in a perspective back view and FIG. 1C shows the seat 1 in a side view,

The seat 1 comprises a seat pan 2, a backrest 3 and optional additionally a headrest 4. Further, the seat 1 comprises two armrest bodies 5, 6 mounted to a backrest structure. The armrest bodies 5, 6 are in particular carrier structures which can be surrounded by foam and/or a covering element to provide a comfortable armrest to an occupant. It is to be noted that the armrest bodies 5 and 6 are configured identical arranged on each side of the backrest 3. The backrest shell 3.1 may be made of foam and/or synthetic material and may be covered by a trim, leather or textile covering. The backrest frame 3.2 may be made of metal and/or synthetic material.

The armrest bodies 5, 6, in particular each base, may be made of synthetic material. Each armrest body 5 and 6 is substantially L-shaped. Each armrest body 5 and 6 is part of an armrest device AD. The armrest device AD is provided on each side, in particular mounted to each lateral portion 3.3 of the backrest 3. For example, the armrest devices AD are mechanically attached to the backrest 3 for simple assembly and disassembly of the armrest devices AD.

For instance, the backrest 3 comprises a backrest shell 3.1 to support a person's back and a backrest frame 3.2, wherein the armrest bodies 5, 6 are mounted to a lateral portion 3.3 of the backrest frame 3.2. In the shown embodiment, the backrest shell 3.1 comprises at least lateral protruding portions 3.1.1. The lateral protruding portions 3.1.1 increase a seating surface and comfort as well as a back support for an occupant. Further, the lateral protruding portions 3.1.1 are each formed in an area of the lateral portion 3.3 of the backrest frame 3.2, wherein each lateral protruding portion 3.1.1 protrudes over an edge of each lateral portion 3.3, in particular at least protruding over a width of the backrest frame 3.2. For example, the lateral protruding portions 3.1.1 are wave-shaped in vertical direction. For example, in an area of the armrest bodies 5 and 6 the lateral protruding portions 3.1.1 comprise a curvature extending in transverse direction.

In another embodiment, the backrest shell 3.1 and the backrest frame 3.2 are of the same size in transverse and vertical direction.

For a better understanding of subsequent descriptions a coordinate system is shown in the figures. The coordinate system comprises a longitudinal axis x, a transverse axis y and a vertical axis z in relation to the seat 1 and/or a not further shown vehicle. For example, the longitudinal axis x defines a longitudinal extending direction and length of the seat 1, the transverse axis y defines a transverse extension direction and width of the seat 1 and the vertical axis z defines a vertical extension direction and height of the seat 1.

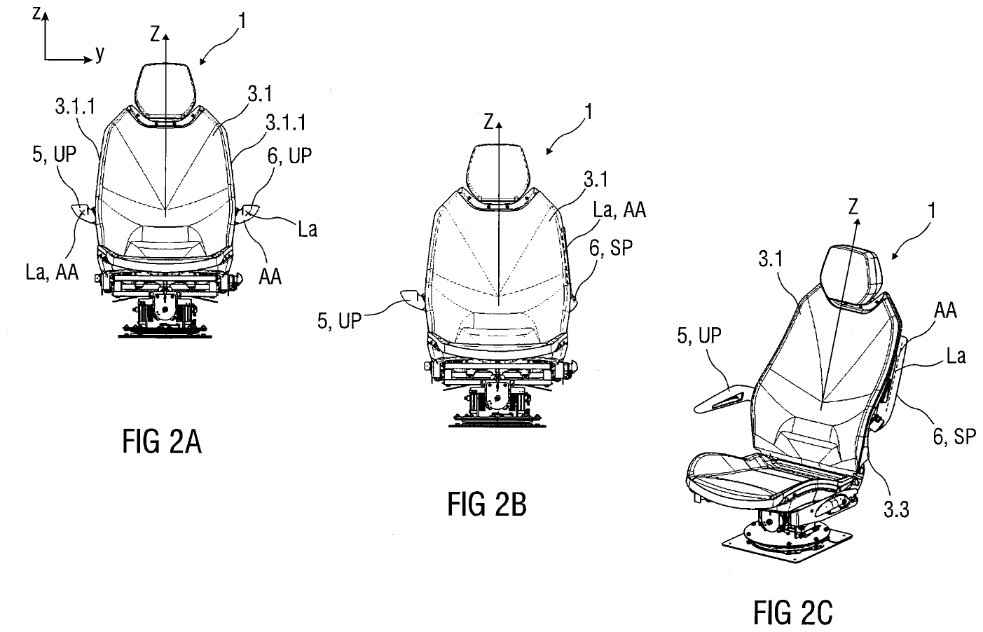

FIGS. 2A and 2B show front views of the seat 1, wherein FIG. 2A shows the armrest bodies 5, 6 of the seat 1 in a horizontal use position UP and FIG. 2B and FIG. 2C show one of the armrest bodies 5 in the horizontal use position UP and the other armrest body 6 in the vertical stowed position SP.

Each armrest device AD comprises an armrest body 5, 6 which is pivotable between the horizontal use position UP and the vertical stowed position SP. Further, the armrest device AD comprises an armrest carrier structure 20. The armrest body 5, 6 is pivotable retained on the armrest carrier structure 20, wherein in the horizontal use position UP the armrest body 5, 6 is located substantially laterally with respect to the armrest carrier structure 20 and the backrest 3, as shown in FIG. 2A. In the vertical stowed position SP the armrest body 5, 6 is located substantially behind the armrest carrier structure 20 and at least the backrest shell 3.1, as shown in FIGS. 2B and 2C. The particularly L-shaped contoured armrest body 5, 6 follows a contour of the backrest 3, in particular of the backrest shell 3.1 and optionally additional its protruding portion 3.1.1. Especially, in the vertical stowed position SP of the armrest body 5, 6, the armrest body 5, 6 is hidden from a line of sight. In the horizontal use position UP the armrest body 5, 6 is closer to a front seating surface of the backrest 3, in particular of the backrest shell 3.1. In the vertical stowed position SP the armrest body 5, 6 is closer to a rear surface of the backrest 3, in particular closer to the backrest frame 3.2. Each armrest body 5, 6 defines a length extension axis La. The length extension axis La runs through a main arm support portion of the armrest body 5, 6.

In the horizontal use position UP of the armrest body 6 a longitudinal axis position AA defined through the armrest body 6, in particular through its extension direction, is positioned perpendicular to a vertical orientation Z of the backrest shell 3.1 and substantially distanced relative to the backrest shell 3.1. In the vertical stowed position SP of the armrest body 6 the longitudinal axis position AA defined through the armrest body 6 is positioned substantially parallel relative to the vertical orientation Z of the backrest shell 3.1 and substantially behind the backrest shell 3.1. In particular, in the vertical stowed position SP the armrest body 6 is aligned adjacent to the lateral portion 3.3 of the backrest 3. The vertical stowed position SP corresponds to a hidden stowed position behind the seat 1. The armrest body 6 can be rotated to a standard useable position and to a hidden stowed position.

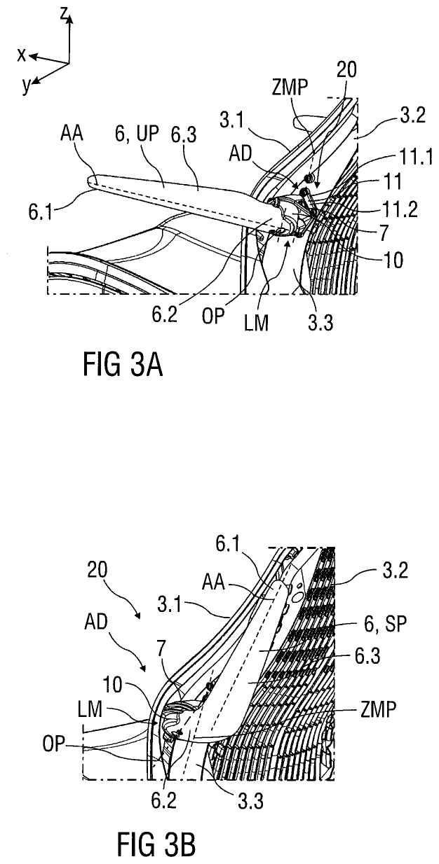

FIGS. 3A and 3B show perspective views of a section of the seat 1, wherein FIG. 3A shows the armrest body 6 in the horizontal use position UP and FIG. 3B shows the armrest body 6 in the vertical stowed position SP. In particular, the armrest body 6 is mounted to the backrest 3 via an armrest device AD.

The armrest device AD comprises the armrest body 6 and an armrest carrier structure 20 to which the armrest 6 is connected to via a single pivot connection. For instance, the armrest carrier structure 20 comprises a vertical mounting plate 11 and a single pivot joint 8 to which the armrest body 6 is pivotable connected to. In particular, the armrest device AD comprises a mounting plate 11 having a first mounting surface 11.1 attached to the backrest 3, in particular to the lateral portion 3.3, such as a frame portion. Further, the mounting plate 11 comprises a second mounting surface 11.2. The armrest carrier structure 20 further comprising a single pivot joint 8 provided on the second mounting surface 11.2 of the mounting plate 11, wherein the single pivot joint 8 defines a pivot axis OP angled away from the mounting plate 11, in particular angled in a direction away from the second mounting surface 11.2. The single pivot joint 8 and so as the pivot axis OP substantially face in a transverse and rear direction with respect to the backrest 3. In a mounted state of the armrest carrier structure 20 the mounting plate 11 is arranged substantially vertically on the lateral portion 3.3 of the backrest 3. The pivot axis OP is angled with respect to the vertical mounting plate 11.

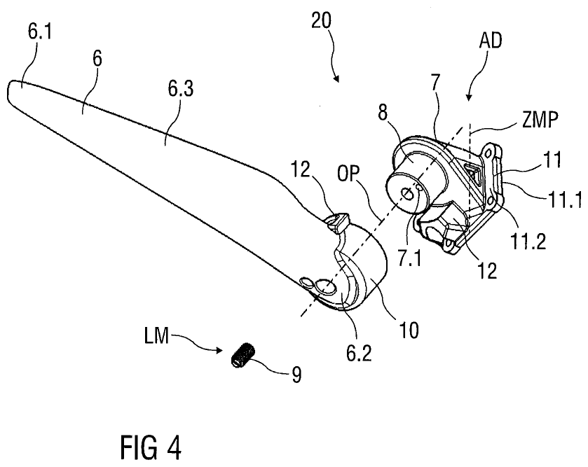

The armrest body 6 is movable between the substantially horizontal use position UP and the substantially vertical stowed position SP. The single pivot joint 8 is angled with respect to the vertical mounting plate 11 and is configured to define a diagonal pivot axis OP, in particular an off-axis pivot about which the armrest body 6 is pivotable. The diagonal pivot axis OP is an axis which is tilted with respect to a vertical axis ZMP defined through the vertical mounting plate 11 such that the length extension axis La defined through the armrest body 6 is positioned off-set in the vertical stowed position SP relative to the length extension axis La of the armrest body 6 in the horizontal use position UP. The pivot joint 8 is shown in more detail in FIG. 4. The pivot joint 8 is angled or rather tilted at about 45° relative to the mounting plate 11, in particular to its vertical axis ZMP. The angled pivot joint 8 allows the armrest 6 to go from the hidden, vertical stowed position SP to a standard, horizontal use position UP and vice versa in one single motion about the diagonal pivot axis OP.

The armrest body 6 comprises a linkage housing 10 which is configured to accommodate the pivot joint 8 of the armrest carrier structure 20. The whole assembly of the armrest device AD is shown in FIG. 4 for better understanding. The armrest body 6 comprises a free end 6.1 and a coupling end 6.2 which is connected to the single pivot joint 8. The coupling end 6.2 comprises the linkage housing 10. The linkage housing 10 may be a separate part which is attached to the coupling end 6.2. The linkage housing 10 and the armrest body 6 may be shaped from one part. The linkage housing 10 comprises a recess which corresponds to the single pivot joint 8. In particular, the armrest carrier structure 20 comprises a bracket 7 mounted on the second mounting surface 11.1 of the mounting plate 11. The single pivot joint 8 is projecting from the bracket 7. The bracket 7 is substantially triangular shaped. For example, the bracket 7 is configured as spacer component.

In the horizontal use position UP, the free end 6.1 of the armrest body 6 points in a fore direction. In the vertical stowed position SP, the free end 6.1 is pointing in an up direction, in particular towards a ceiling of the vehicle.

Moreover, in the horizontal use position UP an upper usage surface 6.3 of the armrest body 6 substantially faces in a direction towards a ceiling of a vehicle. In the vertical stowed position SP the upper usage surface 6.3 substantially faces in a direction away from a front seating surface of the backrest 3, i.e. in an aft direction of the vehicle.

Further, the armrest device AD comprises an integrated locking mechanism LM comprising at least one spring loaded device 9 which is shown in FIG. 4. The spring loaded device 9 is configured to lock the armrest body 6 in at least one of the positions. In particular, the linkage housing 10 is coupled to the armrest carrier structure 20, in particular to its pivot joint 8, by a pin, plunger or a bolt.

FIG. 4 shows an exploded view of the armrest device AD.

The armrest carrier structure 20 comprises the pivot joint 8 which is angled or rather tilted at a 45° axis relative to the mounting plate 11, in particular to its vertical axis ZMP. The mounting plate 11 is attached to a seat structure, particularly the backrest frame 3.2. In particular, the linkage housing 10 is coupled to the armrest carrier structure 20 by the spring loaded device 9.

According to an embodiment, the mounting plate 11 defines a plane, particularly a vertical plane, from which the pivot axis OP is angled away at an angle of about 20° to 50°, for example 25° to 45°, in particular 30° to 40°.

The spring loaded device 9 comprises a ball nose configured to lock the armrest body 6 in the vertical stowed position SP. The armrest carrier structure 20 comprises a locking divot 7.1 into which the ball nose engages for locking the armrest body 6 in the vertical stowed position SP. In particular, the ball nose of the spring loaded device 9 is configured to go into the divot 7.1 and hold the armrest body 6, in particular the linkage housing 10, in the vertical stowed position SP. The spring loaded device 9 is arranged in the linkage housing 10. For example, the linkage housing 10 comprises a recess in which the spring loaded device 9 is fixed to.

For instance, the divot 7.1 is arranged or formed on a surface of the angled pivot joint 8 which faces the armrest body 6, particularly the linkage housing 10. A further divot 7.1 could be added for the horizontal use position UP in order to prevent so called BSR (short for Buzz, Squeak and Rattle) concerns. In particular, the spring loaded device 9 is configured as a so called ball and spring plunger, wherein a plunger encloses a spring element, for instance in a capsule. The spring element is configured to apply accurate and repeatable forces through a ball and/or a rounded nose. When the armrest body 6 is pivoted from the vertical stowed position SP to the horizontal use position UP or vice versa, the ball nose is retracted into the plunger. The ball nose is deployed by the spring element to engage the divot 7.1.

The armrest body 6, in particular the linkage housing 10 and the armrest carrier structure 20 comprise a number of integrated stops 12 which engage each other when the armrest body 6 reaches one of the horizontal use position UP and the vertical stowed position SP.

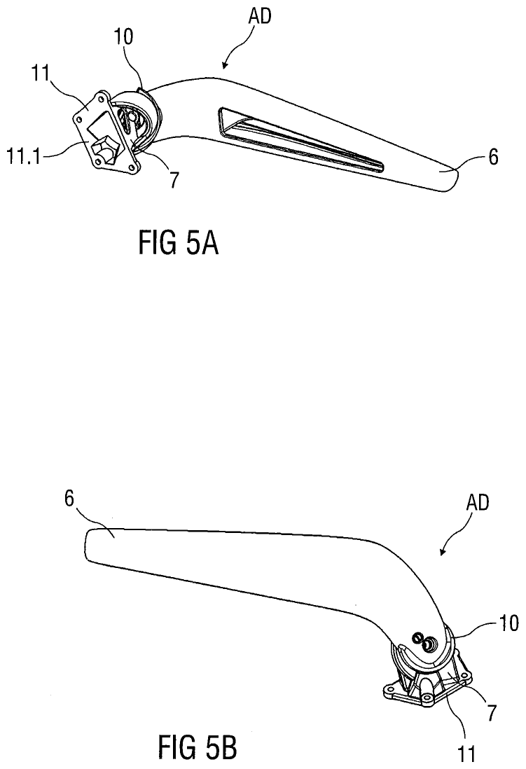

FIGS. 5A and 5B show the armrest device AD in a mounted state.

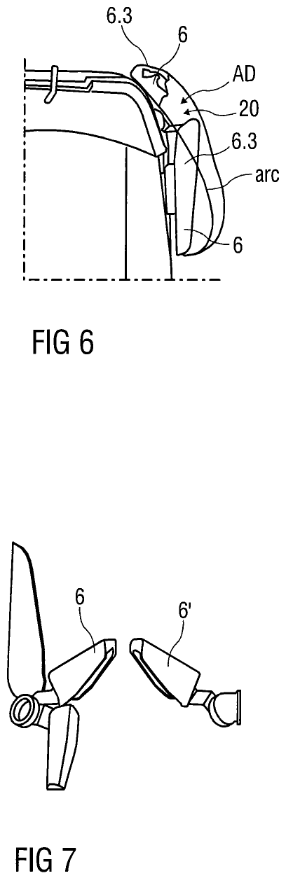

FIG. 6 shows a top view of the seat 1 and an armrest deployment motion along a substantially arcuate path arc which is defined by the armrest device AD or rather its pivot joint 8. The armrest body 6 is moved about the pivot axis OP in a substantially arc-shaped or arched manner between the vertical stowed position SP and the horizontal use position UP. Thereby, the armrest body 6 is movable in an arc-shaped or arched manner about the single pivot joint 8. In particular, a simple sweeping movement or motion may be carried out.

FIG. 7 shows a front view of a clearance between two armrest bodies 6 and 6′, wherein one armrest body 6 is mounted to a passenger seat and the other armrest body 6′ is mounted to a driver seat. The movement of the armrest body 6 does not affect the other armrest body 6′.

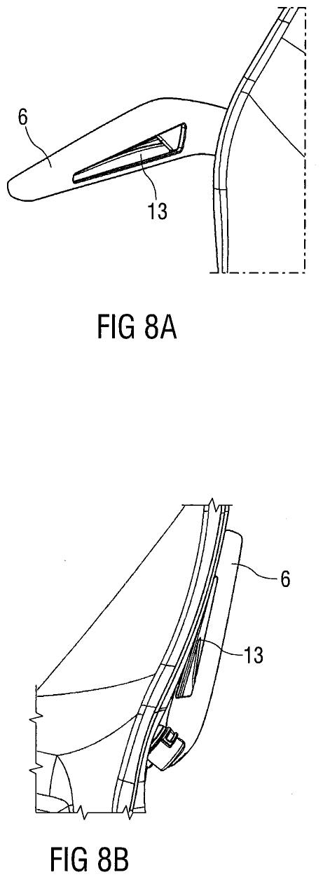

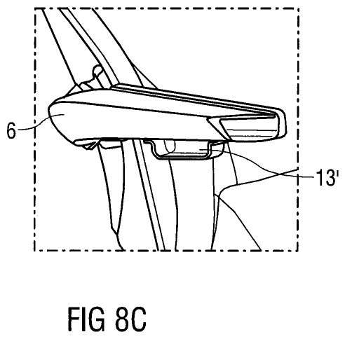

FIGS. 8A to 8C show schematically perspective views of an embodiment of an armrest body 6 with at least one grip portion 13, 13′, wherein FIGS. 8A and 8B show an embodiment of an integrated grip portion 13 which is configured as a cavity on an inside of the armrest body 6 and FIG. 8C shows an embodiment of a grip portion 13′ which is configured as an extension element mounted to a bottom surface of the armrest body 6. The integrated portions 13, 13′ can be easily reached and grabbed by a person to move the armrest body 6 from one position to another position. The armrest body 6 comprises at least one grip portion 13, such as an integrated recess or cut out configured as gripping handle so that the armrest body 6 can be manually moved between the horizontal use position UP and the vertical stowed position SP and vice versa. For example, the grip portion 13 is a recessed grip provided within the armrest body 6. Additionally or optionally, the armrest body 6 comprises an external grip portion 13′, such as a separate component with a recessed grip configured as handle or a gripping bow. The external grip portion 13′ may be attached mechanically or adhered to the armrest body 6, for example to a surface side facing a bottom of the vehicle. Further, the external grip portion 13′ and the armrest body 6 are configured as one-piece, for example as molded one-piece part.

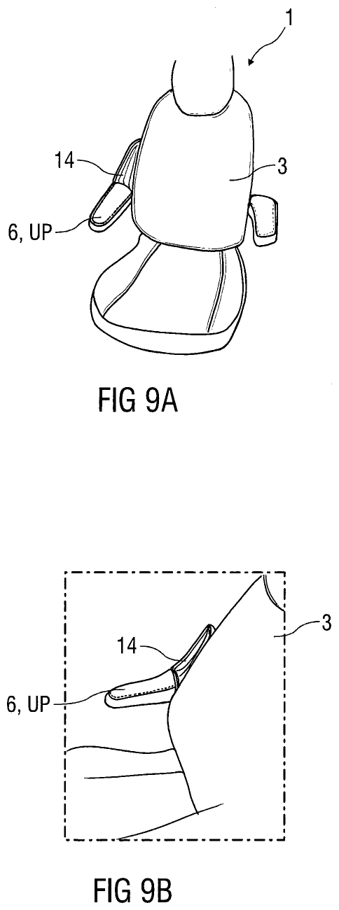

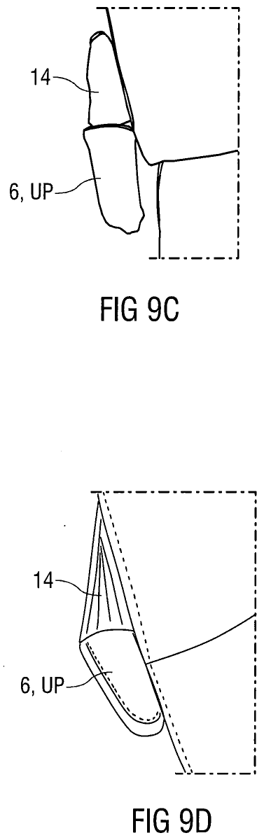

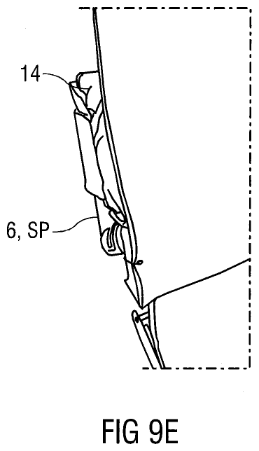

FIGS. 9A to 9E show schematically perspective views of armrest embodiments with an arm support element 14. For example, the arm support element 14 is arranged on a lateral side of the backrest 3. The arm support element 14 is made of fabric as shown in FIG. 9D or also comprises foam as shown in FIGS. 9A to 9C for more comfort. The arm support element 14 is added to a back of the armrest body 6, particularly between the armrest body 6 and the backrest 3 to provide additional support to the elbow and arm of an occupant/passenger in a reading, comfort and/or relaxing position. The arm support element 14 is configured to blend from the back of the armrest body 6 to the side of the backrest 3. The fabric of the arm support element 14 is in tension providing a small hammock for additional elbow/arm support. In particular, the fabric is in tension when the armrest body 6 is deployed, i.e. in the horizontal use position UP, and goes out of tension as the armrest body 6 is folded to the horizontal stowed position SP. The fabric folds behind the seat 1 near the armrest body 6 when stowed. The fabric in tension can comprise foam on a top surface to enhance comfort. Bend points on the foam can be added to improve a folding motion of the arm support element 14 such that the arm support element 14 can be folded more easily when the armrest body 6 moves into the vertical stowed position SP as shown in FIG. 9E. The fabric can be made of elastic material. One end of the arm support element 14 is connected to the coupling end 6.2 of the armrest body 5 to 6′ and the other end is mountable to the backrest 3. The arm support element 14 is an armrest extension which is, for example, made of fabric, textile or synthetic material. The arm support element 14 is configured as a so called hammock extension which is in tension when the armrest body 6 is in the horizontal use position UP and which folds behind the backrest 3, in particular behind the backrest shell 3.1, when the armrest body 6 is stowed. One end of the arm support element 14 is connected to the coupling end 6.2 of the armrest body 6 and the other end is mounted to the backrest 3. For example, the other end of the arm support element 14 is attached to the backrest shell 3.1 and/or to a trim cover of the backrest shell 3.1.

### LIST OF REFERENCES

1 seat
2 seat pan
3 backrest
3.1 backrest shell
3.1.1 protruding portion
3.2 backrest frame
3.3 lateral portion
4 headrest
5, 6, 6′ armrest body
6.1 free end
6.2 coupling end
6.3 upper usage surface
7 bracket
7.1 divot
8 pivot joint
9 spring loaded device
10 linkage housing
11 mounting plate
11.1, 11.2 mounting surface
12 integrated stop
13, 13′ grip portion
14 arm support element
20 armrest carrier structure
AD armrest device
AA axis position
arc arcuate path
LM locking mechanism
La length extension axis
OP pivot axis
SP stowed position
UP use position
Z vertical orientation, in particular of the backrest
ZMP vertical axis, in particular defined through the mounting plate
x longitudinal axis
y transverse axis
z vertical

1-15. (canceled)

16. An armrest device for a backrest of a vehicle seat, comprising:
an armrest body which is pivotable between a horizontal use position and a vertical stowed position, and
an armrest carrier structure comprising a mounting plate having at least a first mounting surface mountable to the backrest and a second mounting surface,
the armrest carrier structure comprising a single pivot joint provided on the second mounting surface of the mounting plate, the single pivot joint defining a pivot axis angled away from the mounting plate,
the armrest body being pivotable connected to the single pivot joint, wherein
in the horizontal use position the armrest body is located substantially laterally with respect to armrest carrier structure and
in the vertical stowed position the armrest body is located substantially behind the armrest carrier structure.

17. The armrest device according to claim 16, wherein the armrest body is continuously movable about the single pivot joint.

18. The armrest device according to claim 16, wherein the armrest body comprises a free end and a coupling end which is connected to the single pivot joint.

19. The armrest device according to claim 18, wherein the coupling end comprises a linkage housing which is configured to accommodate the single pivot joint of the armrest carrier structure.

20. The armrest device according to claim 16, wherein the armrest body is substantially L-shaped.

21. The armrest device according to claim 16, wherein the armrest support carrier comprises a bracket mounted on the mounting plate, wherein the single pivot joint (8) is projecting from the bracket.

22. The armrest device according to claim 16, wherein the mounting plate defines a plane from which the pivot axis is angled away at an angle of about 20° to 50°, including 25° to 45°, and 30° to 40°.

23. The armrest device according to claim 16, wherein the armrest body is moved about the pivot axis in a substantially arc-shaped or arched manner between the vertical stowed position and the horizontal use position.

24. The armrest device according to claim 16, wherein the armrest body and the armrest carrier structure comprise a number of integrated stops which engage each other when the armrest body reaches one of the horizontal use position and the vertical stowed position.

25. The armrest device according to claim 16, wherein the armrest body comprises at least one grip portion to be manually moved between the horizontal use position and the vertical stowed position.

26. The armrest device according to claim 16, wherein the armrest body comprises an arm support element which is deployable and stowable depending on a movement of the armrest body from the vertical stowed position to the horizontal use position and vice versa.

27. The armrest device according to claim 26, wherein in the horizontal use position the armrest body and the arm support element provide a continuous support surface for an occupant.

28. A backrest for a vehicle seat, comprising:
a backrest frame,
a backrest shell arranged on the backrest frame adapted to support a person's back and
an armrest device according to claim 16, wherein the armrest device is attached to a lateral portion of the backrest frame.

29. The backrest according to claim 28, wherein in the horizontal use position the armrest body is located substantially perpendicular to a vertical orientation of the backrest shell and in the vertical stowed position the armrest body is located substantially behind the backrest shell and parallel relative to the vertical orientation of the backrest shell.

30. A vehicle seat, comprising at least a seat pan, and an armrest device according to claim 16 and
a backrest, comprising:
a backrest frame,
a backrest shell arranged on the backrest frame adapted to support a person's back and
the armrest device.
